(19) United States
(12) Patent Application Publication
(10) Pub. No.: US 2006/0155859 A1
(43) Pub. Date: Jul. 13, 2006

(54) Data handling system

(76) Inventor: Bizhan Rahimzadeh, Cheshire (GB)

Correspondence Address: NOTARO AND MICHALOS, 100 DUTCH HILL ROAD, SUITE 110, ORANGEBURG, NY, 10962-2100, US

(21) Appl. No.: 10/533,173

(22) PCT Filed: Oct. 31, 2003
(86) PCT No.: PCT/GB03/04687

§ 371 Date: Dec. 23, 2005

(30) Foreign Application Priority Data
Nov. 2, 2002 (GB) 0225622.0

(51) Int. Cl. G06F 15/16

(52) U.S. Cl. 709/228; 709/204; 709/205

(57) ABSTRACT

A data handling system for multi-user transactions has a central data processing device incorporating a data store structured in accordance with a predetermined progressive transaction involving cooperation between users, and a plurality of data access interfaces for the device for the respective users with defined access privileges. At least some interfaces are read/write interfaces whereby data can be read from and written to the store in relation to predetermined stages of the transaction in accordance with the respective privileges.

This invention relates to a data handling system for multi-user transactions.

In the case of multi-user transactions where progress occurs involving a number of separate parties working together, there may be the requirement for the parties to interchange data between themselves to facilitate tracking of the transaction and/or so that each party can obtain information necessary to enable the transaction to take place.

Thus, by way of example, in the case of freight consignments, which are forwarded between. destinations passing through the hands of different intermediaries, data relating to the consignment is customarily relayed from intermediary to intermediary, with each intermediary adding further information. This helps ensure that the right consignment is correctly routed to the desired destination accompanied by correct documentation. Also data relating to the progress of the transaction may be relayed back to a control location so that progress can be tracked.

In practice this conventional procedure involves the use of forms or other paper documents which are prepared by the intermediaries and passed backwards and forwards between authorised personnel.

In so far as high reliance is placed on the intermediaries themselves with regard to the selection of documents and collection of appropriate information for entry on the documents, this can be inconvenient and frequently prone to error.

Also reliance on the use of paper documentation is generally Inconvenient and may have limitations with regard to accessibility of information.

An object of the present invention is to provide a data handling system which enables multi-user information relating to a transaction to be processed in a versatile, reliable and convenient manner.

According to one aspect of the invention therefore there is provided a data handling system for multi-user transactions comprising a central data processing device incorporating a data store structured in accordance with a predetermined progressive transaction involving cooperation between users, a plurality of data access interfaces for the device for the respective users with defined access privileges, at least some interfaces being read/write interfaces whereby data can be read from and written to the said store in relation to predetermined stages of the said transaction in accordance with the respective said privileges.

With this arrangement, data relating to a progressive transaction can be collected and distributed between multiple parties in a particularly easy and convenient manner. Moreover, as a consequence of the defined access privileges, security of access can be readily ensured, such that access is only available to authorised personnel and also, such that different personnel have different levels of access e.g. To different data. in particular, it can be ensured that a user only has access on a need-to-know' basis e.g. to data which that user has provided or which one or more other users shares with that user.

Preferably, provision may be made for providing to a user information in a predetermined format possibly for downloading as hard copy documentation e.g. as a print out or for bi-directional exchange via a handheld/mobile device and/or bi-directional exchange with other systems belonging to the user. In this way, the user can obtain requisite documentation in a simple, convenient and reliable manner.

With regard to the progressive transaction, this may be of any suitable kind.

In one embodiment, the transaction constitutes forwarding of a freight consignment between destinations passing through the hands of different intermediaries. In this case the interfaces provide data access for the respective intermediaries and possibly also other authorised personnel whereby movements of the identified consignment can be entered as they take place so that the progress of the consignment can be directed, checked and tracked as desired, and requisite shipping documentation or the like can be readily and reliably generated.

Thus, and in accordance with a second aspect of the present invention there is provided a method of tracking movements of freight consignments under the control of a plurality of separate parties wherein each freight consignment has a respective set of data stored at a central data store, and each party has access to the data store for purposes of reading and writing to the data set in accordance with a respective set of permissions.

It is however to be understood that the Invention is not Intended to be restricted to freight consignments. The first aspect of the invention may therefore apply to any other suitable progressive transaction which requires multi-user shared data with controlled access involving different access parameters for different users.

Thus, for example, the transaction may be a legal transaction related to the resolution of a problem in which different parties such as lawyers, courts, welfare officers, etc. may work together each requiring to contribute some information to a pool of shared data and each requiring access to a predetermined sector of this pool.

As a further example, the transaction may be a public project transaction related to construction work or the like where different parties such as utilities, law firms, construction firms, police, local government departments may work together with access to a pool of shared data.

The invention will now be described further by way of example only and with reference to the accompanying drawing in which:

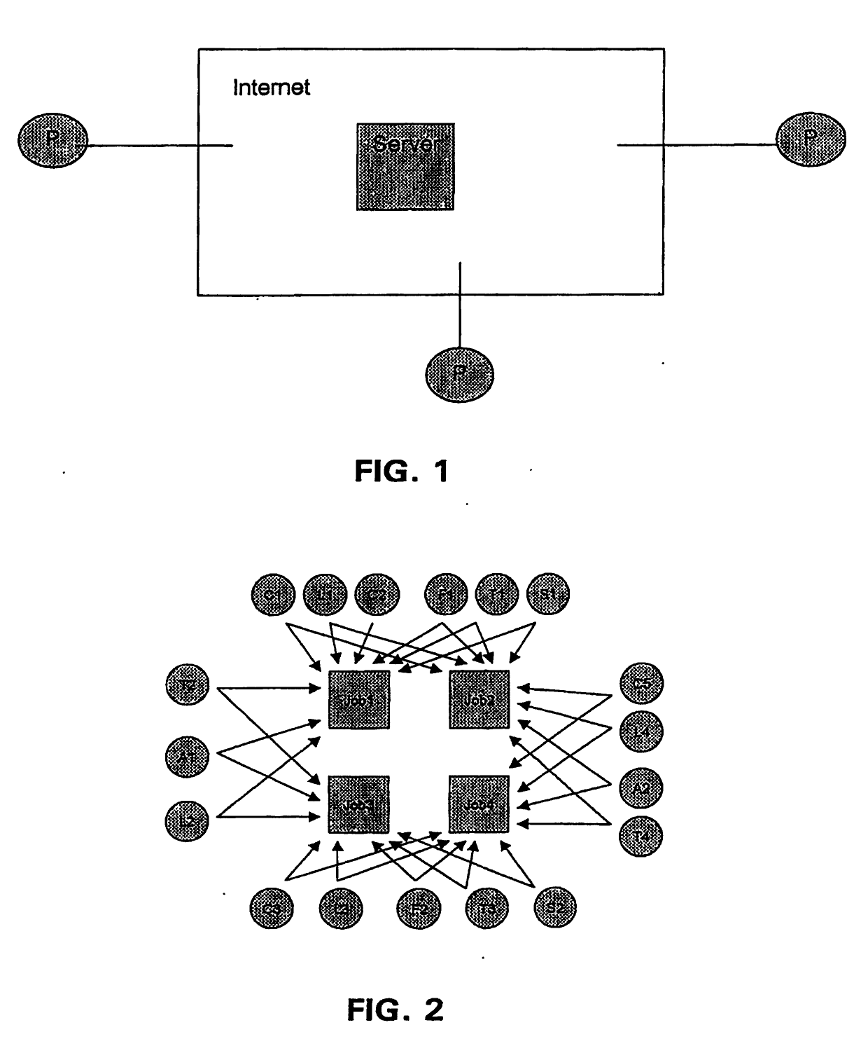

FIG. 1 is a diagrammatic representation of the data-handling system of the invention; and

FIG. 2 is a diagrammatic representation showing interface access to transactions with the system of FIG. 1.

Referring to FIG. 1, the data-handling system comprises a central computer or server which is connected To the Internet or other secure

network capable of handling mass access such as mobile WAP, SMS or other mobile type access as well as external system access such as accounting or other customer based systems (possibly via XML—extensible Mark-up Language, or other technologies).

The server runs software which establishes secure web page or other type of access linked to a processing device and a data store.

Different parties have access to the information on the server from their respective PC terminals or other devices via secure, password protected Internet or other access. These devices may be specified devices at fixeci locations. Preferably however the arrangement is such that access can be gained by an appropriately authorised person or system using any device at any location having suitable connection to the server.

By way of example, the system may be used to conduct transactions consisting of movements of a number of freight consignments here identified as Job 1, 2, 3, 4.

In this example, the respective access devices may be used by the following:

One or more client/end-users who instruct and have overall responsibility for one or more of the transactions;

Freight forwarders;

Transport companies;

Shipping lines;

Agents.

For each transaction, various parties are involved, and various information is required. The parties and the information may be the same or different for different transactions. The Job file lists the parties involved and defines their respective access privileges to every constituent of the Job file.

Thus, for Job 1 there is a client C1 instructing movement of the consignment from Location L1 to Location L2. This is done with the assistance of a Freight Forwarder F1, a Transport Company T1, a Shipping Company S1 and an Agent A1.

Each of these parties is engaged by the client or other authorised intermediaries and is given authorisation to access Job 1 on the server at a predetermined access level.

The server runs implementing software which sets up the structure of Job 1 on the server for use by the client.

Each of the authorised parties accesses Job 1 after entering a user identification and a password andlor possibly using additional security keys. The party can than access the Job or Jobs and can read/amend/edit existing documents where appropriate access privilege exists or create new documents.

This form contains all required information as to the identity and function of this user.

The user can download and print out hard copy documentation e.g. required to accompany the consignment.

When the user has progressed part of the transaction, e.g. by receiving and moving the consignment from location to location, this information is uploaded by the user to the server to be stored in a status section of Job 1.

The user can access this status section to determine current information as to the location and status of the consignment.

An autihorised person with suitable access privileges can read all stored information and also write to portions of the stored data to be read by the other authorised users.

Other persons acting as intermediaries may have limited access privileges so that, Tor example, only part of the stored data can be read or downloaded, and, in the case where data is permitted to be written to the store this may be in relation to only part of the store.

In this way, the users have access to information that relate to them and can conduct further transactions with existing or new parties with respect to current Job. Intermediaries have access to information derived from the client and/or other Intermediaries and can derive up to date status information, create new documents and correct, updated documentation, such as shipping instructions, shipping notes, collection notes, manifests, etc., as and when required.

The server also contains information relating to other jobs: Job 2, Job 3, Job 4.

Users may only have access to information relating to one job, or may have access to multiple jobs depending on their involvement. Different combinations of access by Clients (C), Freight Forwarders (F), Transport Companies (T), Shipping Lines (S) and Agents (A) are shown In FIG. 2.

Information and documents are submitted between partners In a particular job on a selective ‘need-to-know’ basis. Each party can only see documents which that party has created, and documents submitted to that party by a partner in that particular job. Thus, as illustrated, Transport Company T4 is involved with Jobs 2 and 4 but not with Job 1 and 3, and Shipping Line S1 is involved with Jobs 1 and 2 but not Jobs 3 and 4. Transport Company T4 can therefore only share information with Shipping Line S1 in relation to Job 2 and not Job 1.

In addition To facilitating worldwide communication and providing up-to-date information which may not otherwise be readily available, the system described provides access to information and standardised documentation without requiring extensive local investment in equipment. There is the possibility of users accessing information and documentation from anywhere in the world through local Internet access.

It is of course to be understood that the invention is not intended to be restricted to the details of the above embodiment which are described by way of example only.

Thus, for example, instead of the Internet, any other suitable network interconnection between the server and user access devices may be used, including Virtual Private Network technology.

Any suitable number and combination of partners can share information with the system described. Thus, other users, additionally or alternatively to those described, may be involved with a freight consignment transaction such as hauliers, shipbrokers, warehousing/storage companies, airlines, container operators, etc.

Also, the invention is not restricted to freight consignments. The invention may apply to any other suitable transaction or transactions of a progressive or developing nature where multiple users act in partnership with each other to achieve a collective goal. Other examples are:
1. Family law which involves confidential information In predetermined format/structure pooled and shared between a number of parties such as two or more firms of lawyers, the courts, court appointed welfare officers and the non-professional parties.
2. Local government services procurement where an incredible number of organisations including multiple utilities, law firms, construction firms, the police and the multiple council departments are typically involved in a public project such as building a by-pass or new estate of some kind.

1. A data handling system for multi-user transactions comprising a central data processing device incorporating a data store structured in accordance with a predetermined progressive transaction involving cooperation between users, a plurality of data access interfaces for the device for the respective users with defined access privileges, at least some interfaces being read/write interfaces whereby data can be read from and written to the said store in relation to predetermined stages of the said transaction in accordance with the respective said privileges.

2. A system according to claim 1 wherein there are different said defined access privileges giving access to different data.

3. A system according to claim wherein some define access privileges give access to shared data.

4. A system according to claim 1 incorporating means for providing data output as hard copy documentation.

5. A system according to claim 1 incorporating means for bidirectional exchange of said data with a separate user data handling system.

6. A system according to claim 5 wherein the user system comprises a hand held or mobile device.

7. A system according to claim 1 structured for multiple said progressive job transactions.

8. A system according to claim 1 when used for a said transaction which constitutes forwarding of a freight consignment between destinations passing through the hands of different intermediaries.

9. A system according to claim 1 used for a said transaction which constitutes a legal transaction related to the resolution of a problem with different parties working together.

10. A system according to claim 1 when used for a said transaction which constitutes a public project related to construction work with different parties working together.

11. A method of tracking movements of freight consignments under the control of a plurality of separate parties wherein each freight consignment has a respective set of data stored at a central data store, and each party has access to the data store for purposes of reading and writing to the data set in accordance with a respective set of permissions.
